(19) United States
(12) Patent Application Publication
(10) Pub. No.: US 2016/0020625 A1
(43) Pub. Date: Jan. 21, 2016

(54) MOBILE ELECTRONIC DEVICE STORAGE AND CHARGING CABINET

(71) Applicant: Chung Chiao Holding Corp., Taipei City (TW)

(72) Inventor: Wen-Sheng TSOU, Taoyuan County (TW)

(21) Appl. No.: 14/331,637

(22) Filed: Jul. 15, 2014

(51) Int. Cl. H02J 7/00

(52) U.S. Cl. CPC H02J 7/0044; H02J 7/0027

(57) ABSTRACT

A mobile electronic device storage and charging cabinet includes a body including an inner housing surrounded by a bottom panel, two upright side panels and an outer cover panel and having storage compartments defined therein for accommodating mobile electronic devices individually and a sliding door movable along tracks at the upright side panels to close or open the inner housing, and a power supply unit including a power input module for power input, a power socket module mounted in the inner housing and electrically connected to the power input module and battery chargers respectively electrically connected to the power socket module and adapted for charging storage mobile electronic devices. Thus, the invention facilitates centralized management of mobile electronic devices, saves mobile electronic device charging time, improves mobile electronic device charging efficiency and enhances ease of use.

### BACKGROUND OF THE INVENTION

1. Field of the Invention

The present invention relates to storage means for use in a desk or the like for storing mobile electronic devices, and more particularly to a mobile electronic device storage and charging cabinet, which comprises an inner housing defining therein multiple compartments for storing mobile electronic devices individually, a sliding door movable to open or close the inner housing, and a power supply unit for charging all storage mobile electronic devices, facilitating mobile electronic device management and, improving mobile electronic device charging efficiency.

2. Description of the Related Art

With fast development of electronic and multimedia technologies, advanced and sophisticated notebook computers, tablet computer, smart phone, PDA and many other mobile electronic devices have been continuously created and appeared on the market. These mobile electronic devices have the characteristics of small size, light weight and high mobility. With continuous creation of hardware and software functions, mobile electronic devices are widely used in our daily life for different applications.

However, due to the characteristics of small size, light weight and high mobility, these mobile electronic devices can easily be damaged by impact. Protective cases are commercially available protecting mobile electronic devices. However, these commercial protective cases are commonly designed for storing an individual mobile electronic device. Further, a school, organization or office may need to use a large number of tablet computers, notebook computers, PDAs or other mobile electronic devices to satisfy different requirements for information sorting or different software applications. After each use, these mobile electronic devices may be directly left on desks. The use of a large amount of mobile electronic devices brings inconvenience to the person in charge. Further, these mobile electronic devices can be easily stolen.

Putting mobile electronic devices such as notebook computers or tablet computers in protective cases facilitates carrying and enhancing convenience and ease of use. However, conventional protective cases for mobile electronic device do not provide a charging function. This provides an inevitable problem in charging storage mobile electronic devices. Before using a storage mobile electronic device, the user must electrically connect the mobile electronic device to an external power source by a power connector or battery charger, enabling the mobile electronic device to be fully charged. In consequently, the overall effect of use and convenience would be restricted. If there is a large amount of notebook computers or tablet computers to be electrically charged, the user must individually connect the battery chargers of the notebook computers or tablet computers to respective power sockets for charging, complicating the arrangement of the power cables and prolonging the charging time. An improvement in this regard is desired.

### SUMMARY OF THE INVENTION

The present invention has been accomplished under the circumstances in view. It is the main object of the present invention to provide a mobile electronic device storage and charging cabinet, which facilitates centralized management of mobile electronic devices, saves mobile electronic device charging time, improves mobile electronic device charging efficiency and enhances ease of use.

To achieve this and other objects of the present invention, a mobile electronic device storage and charging cabinet of the invention comprises a body including an inner housing surrounded by a bottom panel, two upright side panels and an outer cover panel and having storage compartments defined therein for accommodating mobile electronic devices individually and a sliding door movable along tracks at the upright side panels to close or open the inner housing, and a power supply unit including a power input module for power input, a power socket module mounted in the inner housing and electrically connected to the power input module and battery chargers respectively electrically connected to the power socket module and adapted for charging storage mobile electronic devices.

Preferably, the inner housing of the body further comprises a mounting space for the mounting of power sockets of the power socket module, a jamb located between the accommodation and the mounting space, and a plurality of cable retainers mounted at the jamb at different elevations corresponding to the storage compartments and adapted for securing the transmission lines of the battery chargers to prevent people from stretching or tripping over the transmission lines and further interruption of connection between the mating connectors of the transmission lines of the battery chargers and the power sockets of the power socket module or damage of the power sockets of the power socket module.

Further, the bottom panel of the body comprises a front stop flange, a lock hole located in the front stop flange, and a plurality of casters pivotally mounted in a bottom wall of the bottom panel. Further, the sliding door comprises a plurality of door slats hinged to one another, a front bar hinged to a first one of the door slats and stoppable at the front stop flange, a grip located at the front bar, and a lock mounted in the front bar. Further, the lock comprises a swivel hook rotatable with a key between a locking position where the swivel hook is engaged into the lock hole in the front stop flange of the bottom panel and an unlocking position where the swivel hook is disengaged from the lock hole.

Further, the outer cover panel comprises a plurality of hanging holes for enabling the mobile electronic device storage and charging cabinet to be hung on nails in a wall. Further, each upright side panel comprises a handhold groove located in an outer wall thereof, a locating groove located in a top side thereof, and a locating flange located in an opposing bottom side thereof and configured subject to the configuration of said locating groove. Thus, multiple mobile electronic device storage and charging cabinets can be arranged in a stack by fastening the locating flanges at the upright side panels of one mobile electronic device storage and charging cabinet to the locating grooves at the upright side panels of another mobile electronic device storage and charging cabinet.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a mobile electronic device storage and charging cabinet on an open status in accordance with the present invention.

FIG. 2 is an exploded view of the mobile electronic device storage and charging cabinet in accordance with the present invention.

FIG. 3 corresponds to FIG. 2 when viewed from another angle.

FIG. 4 is a schematic drawing illustrating a status of use of the mobile electronic device storage and charging cabinet in accordance with the present invention.

FIG. 5 is a front view of the present invention, illustrating multiple mobile electronic devices respectively stored in the storage compartments in the inner housing and charged by the power supply unit.

FIG. 6 is an oblique top elevational view of the present invention, illustrating the mobile electronic device storage and charging cabinet closed.

FIG. 7 is a schematic applied view illustrating the arrangement of two mobile electronic device storage and charging cabinets in accordance with the present invention (I).

FIG. 8 is a schematic applied view illustrating the arrangement of two mobile electronic device storage and charging cabinets in accordance with the present invention (II).

### DETAILED DESCRIPTION OF THE PREFERRED EMBODIMENT

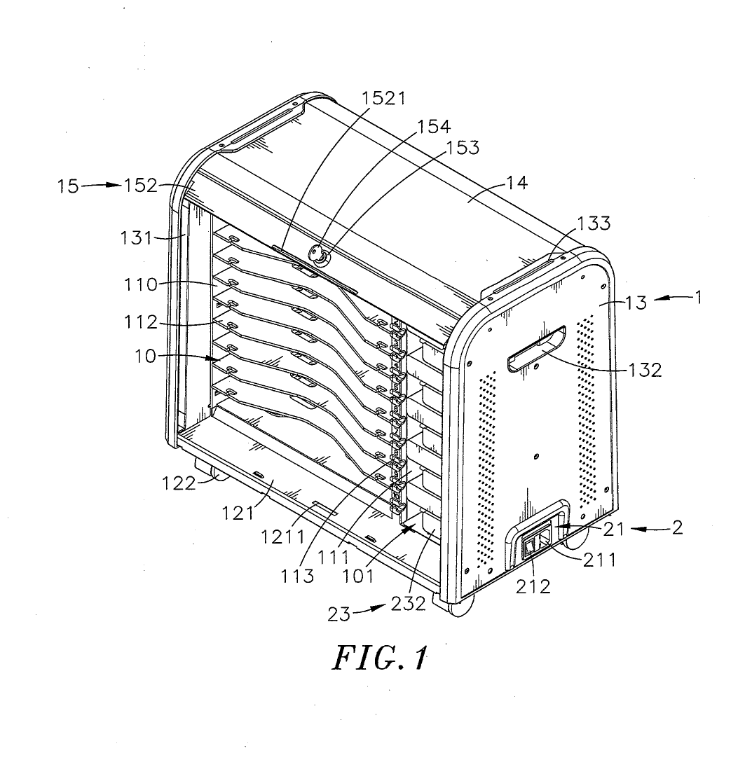

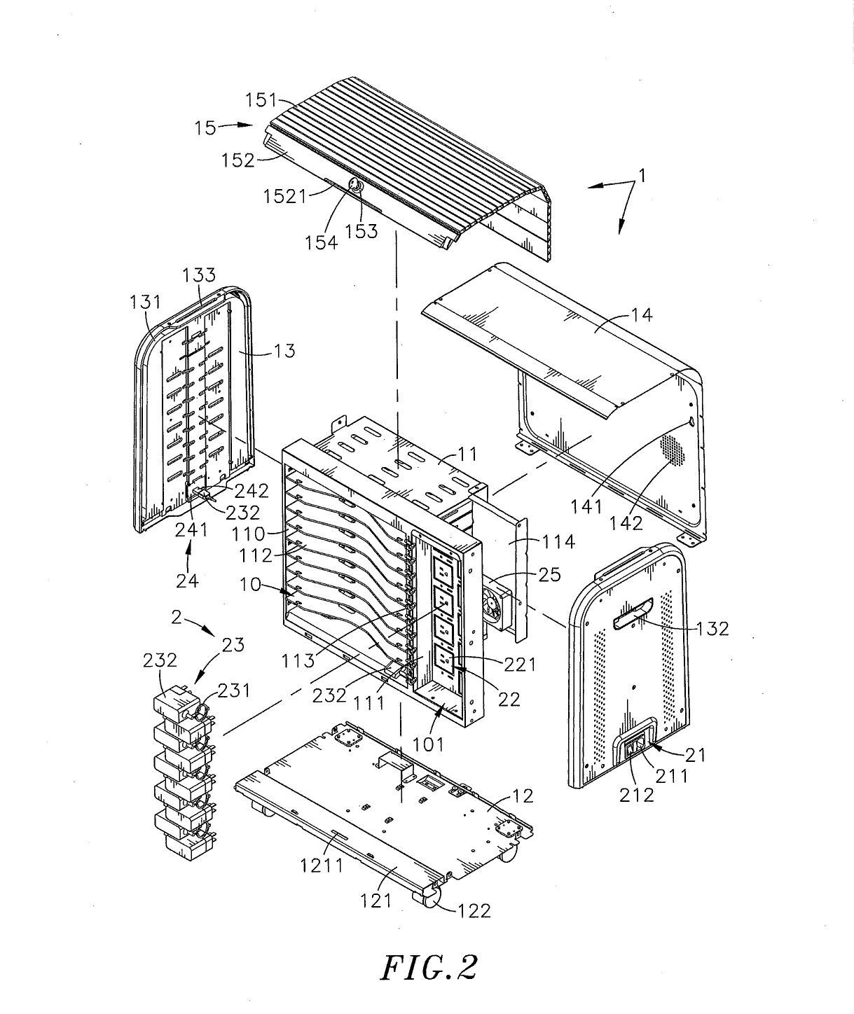

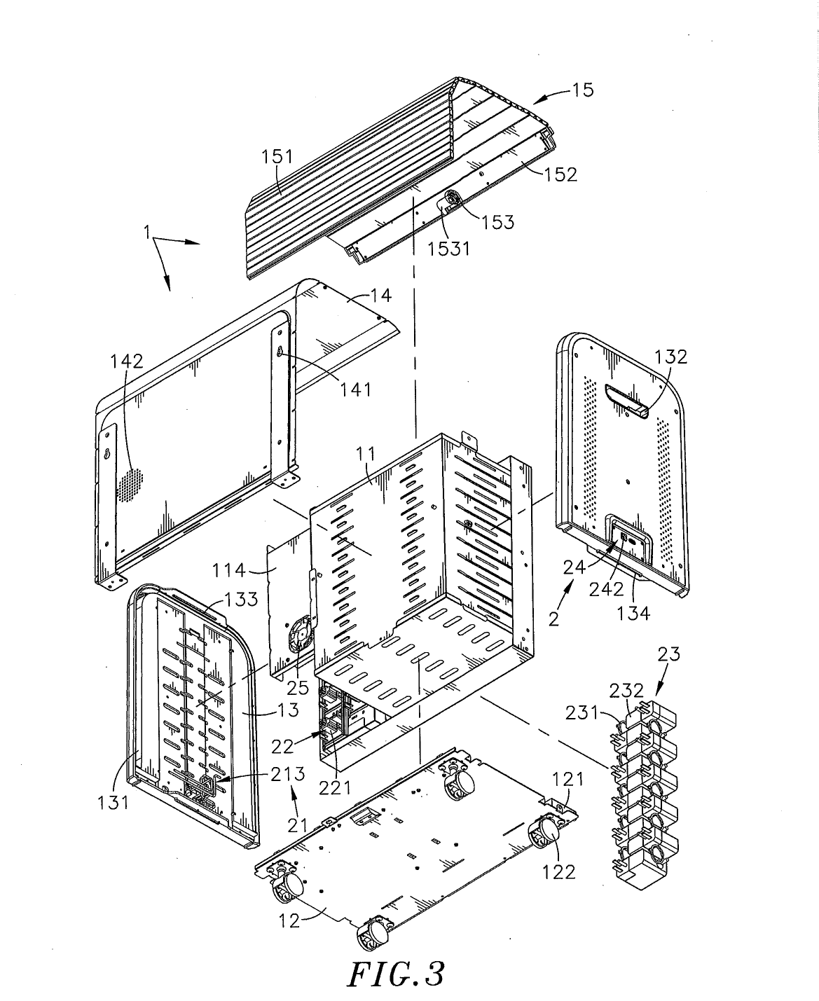

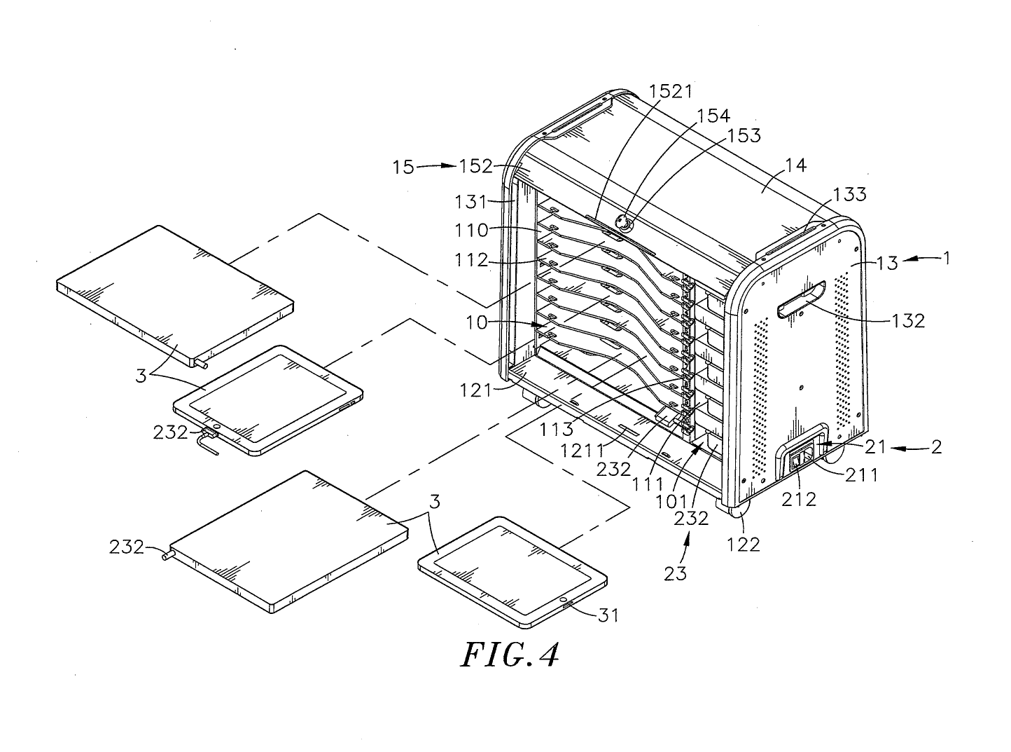

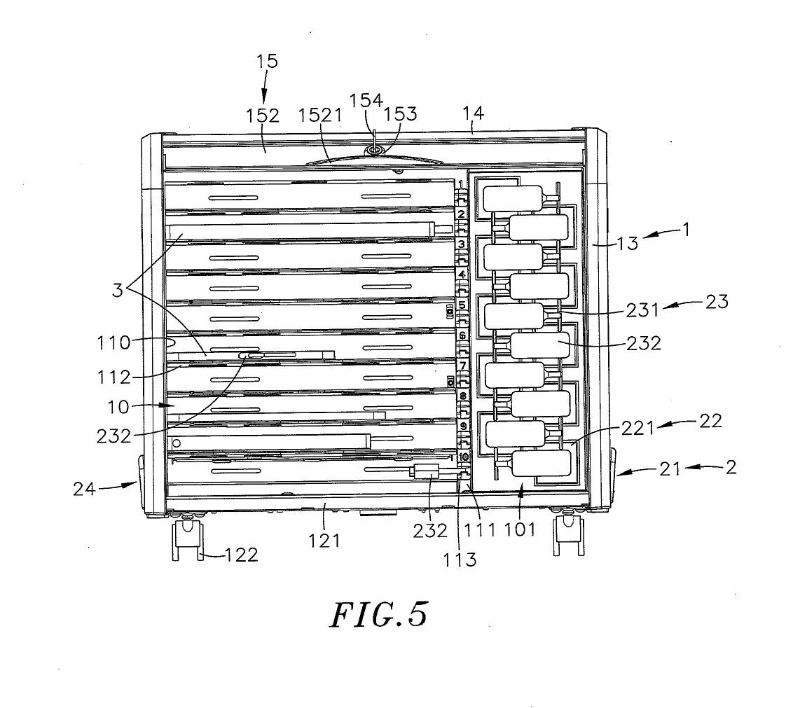

Referring to FIGS. 1-5, a mobile electronic device storage and charging cabinet in accordance with the present invention is shown. The mobile electronic device storage and charging cabinet comprises a body 1, and a power supply unit 2.

The body 1 comprises an inner housing 11, a bottom panel 12, two upright side panels 13, an outer cover panel 14, and a sliding door 15. The inner housing 11 comprises a forward-facing accommodation chamber 10, a mounting space 101 defined in a front side thereof and disposed at one lateral side of the accommodation chamber 10, a jamb 111 located in the front side between the accommodation chamber 10 and the mounting space 101, a plurality of horizontal partition plates 112 mounted in the accommodation chamber 10 at different elevations and dividing the accommodation chamber 10 into a plurality of vertically spaced storage compartments 110, a plurality of cable retainers 113 mounted in a front side of the jamb 111 at different elevations corresponding to the storage compartments 110, and an upright rear panel 114 disposed at a rear side relative to the mounting space 101.

The bottom panel 12 is mounted at a bottom side of the inner housing 11, comprising a front stop flange 121 located at a front side of a top wall thereof, a lock hole 1211 located in a middle part of a top side of the front stop flange 121, and a plurality of casters 122 pivotally mounted in a bottom wall thereof. The two upright side panels 13 are respectively mounted at two opposite lateral sides of the inner housing 11, each comprising an inverted U-shaped track 131 extending along a border area of an inner wall thereof, a handhold groove 132 located in an opposing outer wall thereof, a locating groove 133 located in a top side thereof, and a locating flange 134 located in an opposing bottom side thereof. The outer cover panel 14 is fastened to the two upright side panels 13 and covered over top and back sides of the inner housing 11, comprising a plurality of keyway-shaped hanging holes 141 at a relatively higher elevation and a plurality of radiation holes 142 at a relatively lower elevation. The sliding door 15 is coupled to the two upright side panels 13 and movable along the racks 131 of the two upright side panels 13 between a close position where the sliding door 15 blocks a front side of the inner housing 11 and an open position where the sliding door 15 is received in the outer cover panel 14 to open the accommodation chamber 10 of the inner housing 11 for enabling the user to access to the storage compartments 110. The sliding door 15 comprises a plurality of door slats 151 transversely arranged in parallel and hinged to one another, a front bar 152 hinged to a first one of the door slats 151 and movable with the door slats 151 along the tracks 131 of the upright side panels 13, a grip 1521 located on a middle part of a front side of the front bar 152, a lock 153 mounted in the front bar 152, and a key 154 insertable into the keyway (not shown) of the lock 153 and rotatable to bias a swivel hook 1531 of the lock 153 in and out of the lock hole 1211.

The power supply unit 2 comprises a power input module 21, at least one power socket module 22, a plurality of battery chargers 23, an expansion module 24, and a cooling fan 25. The power input module 21 comprises a power connector 211, and a power switch 212 operable to switch on/off the power connector 211. The power connector 211 can be a power socket or power plug. In this embodiment, the power connector 211 is a power socket electrically connects to an external power source (city power supply outlet, power adapter or power generator) by a power cable (not shown). The power socket module 22 comprises a plurality of power sockets 221 mounted in the mounting space 101 of the inner housing 11 at different elevations and respectively connected to the power connector 211 by a respective electrical wire 213. Thus, external AC power supply can be inputted into the power connector 211 and then transmitted to the power sockets 221 of the power socket module 22. Each battery charger 23 comprises a transmission line 231, and two mating connectors 232 (USB connector, power connector or thunderbolt connector) located at two opposite ends of the transmission line 231. The mating connector 232 at one end of the transmission line 231 can be connected to one respective power socket 221 of the power socket module 22 or one of multiple USB sockets 242 at a circuit board 241 of the expansion module 24. The cooling fan 25 is electrically connected to another power socket 242 of the expansion module 24 and adapted for circulating the air through the mobile electronic device storage and charging cabinet to lower the temperature.

In installation, mount the power input module 21 of the power supply unit 2 in a bottom side of one upright side panel 13 of the body 1 to expose the power connector 211 and the power switch 212 to the outside of the upright side panel 13, and then mount the power socket 221 of the power socket module 22 in the mounting space 101 of the inner housing 11, and then fasten the transmission lines 231 of the battery chargers 23 to the respective cable retainer 113 in the inner housing 11 and rest the respective mating connectors 232 of the battery chargers 23 in the respective storage compartment 110 and bind up the excessive part of the transmission lines 231 or wind the excessive part of the transmission lines 231 on a bobbin (not shown) to prevent people from stretching or tripping over the transmission lines 231 and further interruption of connection between the mating connectors 232 and the power sockets 221 or damage of the power sockets 221. Thus, the invention facilitates the connection between the battery chargers 23 and the power socket 221 and arrangement of the transmission lines 231 of the battery charger 23. Thereafter, mount the expansion module 24 of the power supply unit 2 in a bottom side of the other upright side panel 13 of the body 1 to expose the power sockets 242 at one side of the circuit board 241 to the outside of the associating upright side panel 13, and then mount the cooling fan 25 in the upright rear panel 114 of the inner housing 11 to face toward the radiation holes 142 of the outer cover panel 14 and then electrically connect the cooling fan 25 to one power socket 242 at an opposite side of the circuit board 241. Thus, the battery chargers 23 can convert AC power supply to DC power supply and output converted DC power supply to the expansion module 24 and then the cooling fan 25. During operation of the cooling fan 25, outside cooling air is pulled into the inside of the body 1 to circulate through radiation holes 142 of the outer cover panel 14, carrying waste heat away from the power socket module 22.

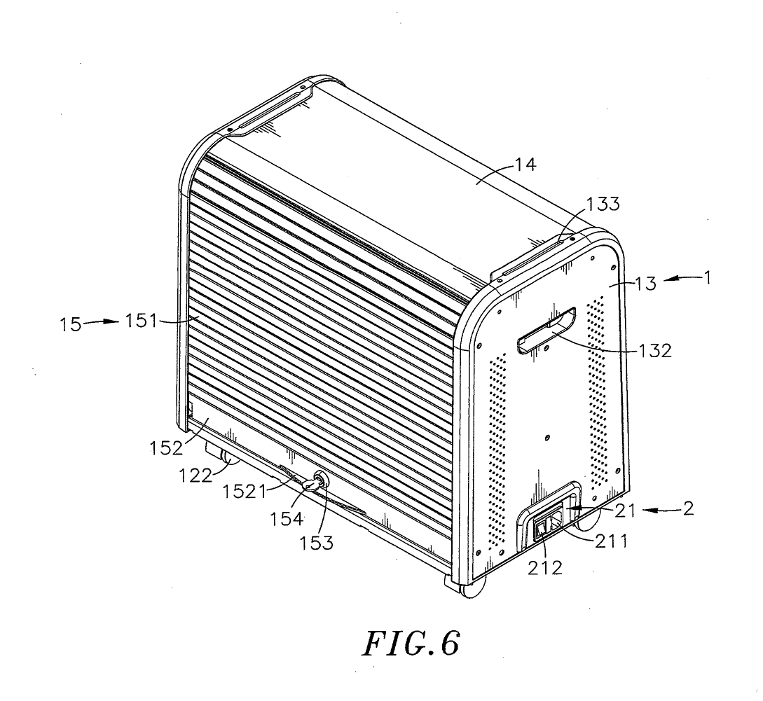

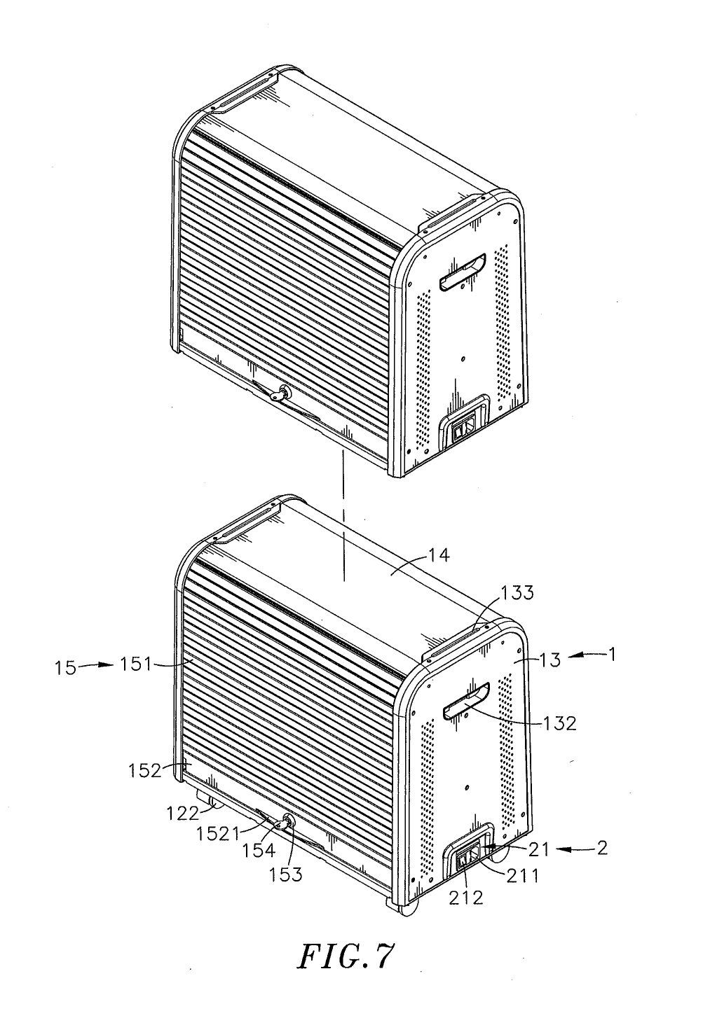

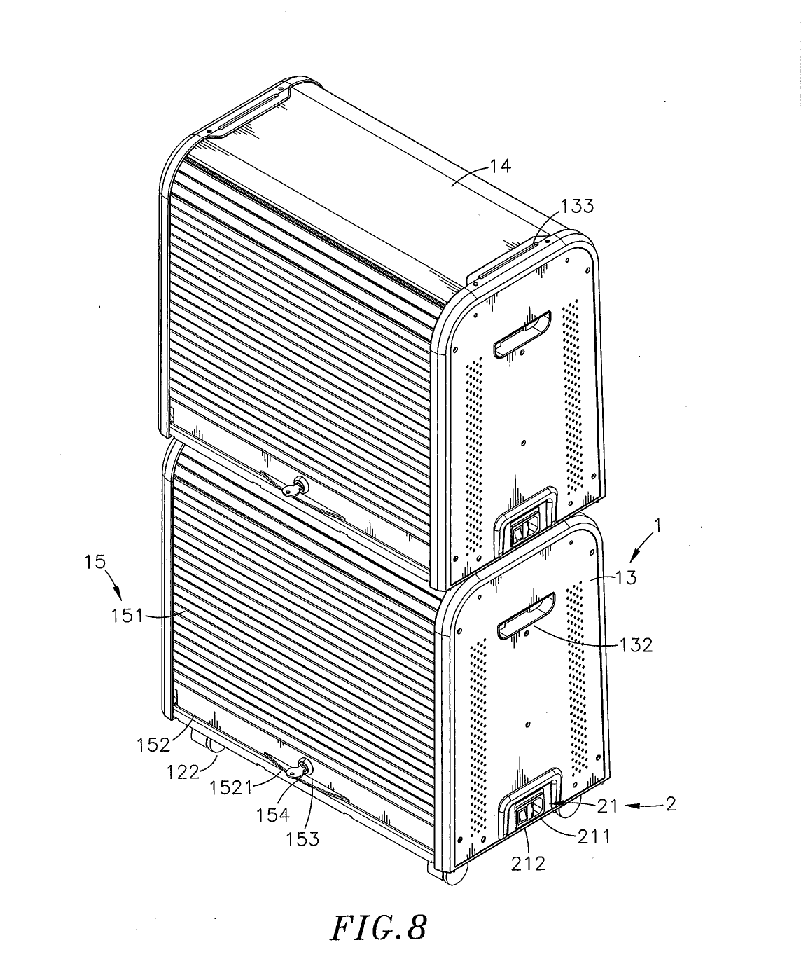

Referring to FIGS. 6, 7 and 8, in application, the user can hold the handhold grooves 132 in the upright side panels 13 to carry the body 1 or to place the body 1 on the table, floor or any other platform. Further, through the casters 122 at the bottom panel 12, the user can move the body 1 from place to place conveniently with less effort. Further, the user can individually connect the mating connectors 232 of the battery chargers 23 to respective connection slots 31 of multiple mobile electronic devices 3 (such as notebook computers or tablet computers) and then put the mobile electronic devices 3 in the storage compartment 110 inside the inner housing 11, facilitating centralized management of the mobile electronic devices 3. At this time, the user can connect the power input module 21 of the power supply unit 2 to an external power source for enabling inputted power supply to be transmitted through the power socket module 22 to the battery chargers 23 to charge the mobile electronic devices 3, saving mobile electronic device charging time, improving mobile electronic device charging efficiency and enhancing ease of use.

Further, the user can open or close the sliding door 15 of the body 1. When opening the sliding door 15, pull the grip 1521 at the front bar 152 to move the front bar 152 and the door slats 151 along the tracks 131 of the upright side panels 13 upwardly to the inside of the outer cover panel 14. After opened the sliding door 15, the user can access to the storage compartments 110 in the inner housing 11 to put mobile electronic devices 3 in storage compartments 110 for storage and charging, or to take the stored mobile electronic devices 3 out of the storage compartments 110 for application. When closing the sliding door 15, pull the grip 1521 at the front bar 152 to move the front bar 152 and the door slats 151 downwardly along the tracks 131 of the upright side panels 13 to the position where the bottom side of the front bar 152 is stopped at the front stop flange 121 of the bottom panel 12. At this time, the user can insert the key 154 into the lock 153 and operate the key 154 to bias the swivel hook 1531 of the lock 153 into the lock hole 1211 in the front stop flange 121, thereby locking the front bar 152 to the front stop flange 121 of the bottom panel 12. After the front bar 152 is locked to the front stop flange 121 of the bottom panel 12, remove the key 154 from the lock 153. Thus, the invention can effectively prohibit the stored mobile electronic devices 3 from being stolen, assuring a high level of security.

The body 1 can be positioned on the table, floor or any other platform. Further, by means of the hanging holes 141 in the outer cover panel 14, the body 1 can be hung on nails on a wall, saving table top or floor space. Further, multiple mobile electronic device storage and charging cabinets can be arranged in a stack like the arrangement of commercial storage boxes, storage cabinets or exhibition cabinets. When stacking up multiple mobile electronic device storage and charging cabinets, remove the casters 122 from the bottom panels 12 of the bodies 1, and then attach the locating flanges 134 of the upright side panels 13 of the body 1 of one mobile electronic device storage and charging cabinet to the locating grooves 133 of the upright side panels 13 of the body 1 of another mobile electronic device storage and charging cabinet. Thus, by means of fastening the locating flanges 134 of one mobile electronic device storage and charging cabinet to the locating grooves 133 of another mobile electronic device storage and charging cabinet, multiple mobile electronic device storage and charging cabinets can conveniently be arranged in a stack.

In conclusion, the invention provides a mobile electronic device storage and charging cabinet for storing and charging multiple mobile electronic devices. The mobile electronic device storage and charging cabinet comprises a body 1, which comprises an inner housing 11 that comprises an accommodation chamber 10, a mounting space 101, a jamb 111 located between the accommodation chamber 10 and the mounting space 101 and a plurality of horizontal partition plates 113 mounted in the accommodation chamber 10 at different elevations to divide the accommodation chamber 10 into multiple storage compartments 110, a bottom panel 12 mounted at a bottom side of the body 1, two upright side panels 13 mounted at two opposite lateral sides of the body 1 and respectively provided with a track 131, an outer cover panel 14 connected between the upright side panels 13 over top and back sides of the inner housing 11 and a sliding door 15 movable along tracks 131 at the upright side panels 13 between a close position to close the inner housing 11 and an open position to open the inner housing 11, and a power supply unit 2, which comprises a power input module 21 electrically connectable to an external power source for power input, a power socket module 22 consisting of a plurality of power sockets 221 and mounted in the mounting space 101 of the inner housing 11 and electrically connected to the power input module 21 and a plurality of battery chargers 23 respectively electrically connected to the power sockets 221 and having mating connectors 232 of transmission lines 231 thereof connectable to respective connection slots 31 of the mobile electronic devices 3 being stored in the storage compartments 110. Thus, the invention facilitates centralized management of mobile electronic devices 3, saves mobile electronic device charging time, improves mobile electronic device charging efficiency and enhances ease of use.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mobile electronic device storage and charging cabinet, comprising:
a body comprising an inner housing, said inner housing comprising an accommodation chamber, a mounting space, a jamb located between said accommodation chamber and said mounting space and a plurality of horizontal partition plates mounted in said accommodation chamber at different elevations to divide said accommodation chamber into a plurality of storage compartments for storing mobile electronic devices individually, a bottom panel mounted at a bottom side of said body, two upright side panels mounted at two opposite lateral sides of said body, each said upright side panel comprising a track extending along the border area of an inner wall thereof, an outer cover panel connected between said upright side panels over top and back sides of said inner housing and a sliding door movable along the tracks of said upright side panels between a close position to close said inner housing and an open position to open said inner housing; and
a power supply unit comprising a power input module electrically connectable to an external power source for power input, a power socket module consisting of a plurality of power sockets and mounted in said mounting space of said inner housing and electrically connected to said power input module and a plurality of battery chargers respectively electrically connected to said power sockets, each said battery charger comprising a transmission line and two mating connectors respectively located at two opposite ends of said transmission line and respectively electrically connectable to one said power socket of said power socket module and a connection slot of one mobile electronic device being stored in one said storage compartment.

2. The mobile electronic device storage and charging cabinet as claimed in claim 1, wherein said inner housing further comprises a plurality of cable retainers mounted at said jamb at different elevations corresponding to said storage compartments and adapted for securing the transmission lines of said battery chargers.

3. The mobile electronic device storage and charging cabinet as claimed in claim 1, wherein said inner housing further comprises an upright rear panel disposed at a rear side relative to said mounting space; said power supply unit further comprises an expansion module mounted in a bottom side of one said upright side panel and electrically connected to said power input module, and a cooling fan mounted in aid upright rear panel and electrically connected to said expansion module.

4. The mobile electronic device storage and charging cabinet as claimed in claim 3, wherein said outer cover panel comprises a plurality of keyway-shaped hanging holes for hanging on nails in a wall, and a plurality of radiation holes facing toward said cooling fan.

5. The mobile electronic device storage and charging cabinet as claimed in claim 3, wherein said expansion module comprises a circuit board, and two electrical connectors located at two opposite sides of said circuit board, the electrical connector at one side of said circuit board being electrically connected to one mating connector at one end of the transmission line of one said battery charger, the electrical connector at the other side of said circuit board being electrically connected to said cooling fan.

6. The mobile electronic device storage and charging cabinet as claimed in claim 1, wherein said bottom panel of said body comprises a front stop flange, a lock hole located in said front stop flange, and a plurality of casters pivotally mounted in a bottom wall of said bottom panel; said sliding door comprises a plurality of door slats hinged to one another, a front bar hinged to one said door slat and stoppable at said front stop flange, and a lock mounted in said front bar, said lock comprising a swivel hook rotatable with a key between a locking position where said swivel hook is engaged into said lock hole and an unlocking position where said swivel hook is disengaged from said lock hole.

7. The mobile electronic device storage and charging cabinet as claimed in claim 6, wherein said front bar of said sliding door comprises a grip spaced below said lock.

8. The mobile electronic device storage and charging cabinet as claimed in claim 1, wherein each said upright side panel comprises a handhold groove located in an outer wall thereof, a locating groove located in a top side thereof, and a locating flange located in an opposing bottom side thereof and configured subject to the configuration of said locating groove.

9. The mobile electronic device storage and charging cabinet as claimed in claim 1, wherein said power input module of said power supply unit comprises a power connector electrically connectable to an external power source, and a power switch operable to switch on/off said power connector.

10. The mobile electronic device storage and charging cabinet as claimed in claim 9, wherein said power socket module of said power supply unit comprises a plurality of power sockets mounted in said mounting space of said inner housing at different elevations and respectively connected to said power connector of said power input module by a respective electrical wire; the mating connector at one end of said transmission line of each said battery charger is electrically connected to one respective said power socket of said power socket module.

11. The mobile electronic device storage and charging cabinet as claimed in claim 9, wherein said power input module of said power supply unit is mounted in a bottom side of one upright side panel of said body to expose said power connector and said power switch to the outside of the respective said upright side panel; said power connector of said power input module is selected from the group of power plug and power socket.

12. The mobile electronic device storage and charging cabinet as claimed in claim 1, wherein said power supply unit further comprises an expansion module mounted in a bottom side of one said upright side panel, said expansion module comprising a circuit board and a plurality of a plurality of sockets arranged at two opposite sides thereof; the mating connector at the other end of said transmission line of each said battery charger is electrically connected to one socket at one side of said circuit board of said expansion module.
